(19) United States
(12) Patent Application Publication
(10) Pub. No.: US 2013/0069878 A1
(43) Pub. Date: Mar. 21, 2013

(54) Portable computer with adjustable keyboard

(71) Applicant: Henan Li, Shenzhen (CN)

(72) Inventor: Henan Li, Shenzhen (CN)

(21) Appl. No.: 13/200,173

(22) Filed: Sep. 19, 2011

(51) Int. Cl. G06F 3/02

(52) U.S. Cl. 345/168

(57) ABSTRACT

A portable computer includes a display device and a computer coupling with the display device to fold between a storage position and an operation position. The computer includes a main body movably coupling with the display device and an input device movably coupled with the main body. At the storage position, the input device and the display device are moved toward the main body that the display device is overlapped with the input device. At the operation position, the display device is moved away from the main body and is elevated by the main body at a predetermined eyelevel with respect to the working surface while the input device is moved away from the main body at a direction opposite to the display device for offering an extended length from the display device.

### BACKGROUND OF THE PRESENT INVENTION

1. Field of Invention

The present invention relates to a portable computer, and more particular to a portable computer with an adjustable keyboard, wherein the keyboard is selectively adjusted its position via the main body for ergonomically fitting the hand position of the user while the screen is elevated for enhancing the viewability of the screen.

2. Description of Related Arts

When buying a computer, the most popular question asked is “Should I buy a notebook or desktop computer?” Desktop computer is typically resided on a desk and generally comprises a tower, a screen monitor, and an input device such as keyboard and mouse. Desktop computer offers better ergonomics since the screen monitor can be selectively elevated at a desired position on the desk for enhancing the viewability of the screen monitor and the keyboard can be selectively adjusted for ergonomically fitting the hand position of the user.

However, desktop computer is tied to one place and requires a relatively large desk space for monitor and input device residing thereon. In addition, the user is unable to carry the desktop computer and to use the desktop anywhere.

Notebook computer generally comprises a screen panel pivotally coupled with an input panel, wherein the screen panel is adapted to be pivotally flipped on the input panel to form a compact structure. Likewise, notebook computer is easy to pack up and can be used anywhere. In recent years, the key specifications, such as CPU, RAM, graphics adapter, and hard drive, of the notebook computer are almost the same as the key specifications on desktop computer. Therefore, most users prefer having a notebook computer at home since the almost everything can be done on the notebook computer that it can be do on the desktop computer and the price of the notebook computer is almost the same as the price of the desktop computer.

However, it is impossible to set up the notebook computer in such an ergonomic way. Accordingly, the input panel is laid flat on the desk surface, wherein the input device, including touchpad and keyboard, is located on the top side of the input panel. Therefore, the input device is orientated in horizontal level such that the wrists/hands of the user will have not support. In other words, the wrists of the user will be twisted in a non-neutral position when the fingers are placed on the keys. Such typing posture will increase the workload on the wrists, forearms and shoulders of the user. In addition, the screen panel can only be adjusted its tilted angle with respect to the input panel. In other words, the screen panel cannot be elevated to match with the eyelevel of the user. To avoid neck fatigue and headaches, the screen panel should be adjusted to eyelevel and about an arm length from the user. A proper screen position is that the user should be looking slightly downward to view the screen on the screen panel. However, the structural configuration of the notebook computer does not allow the user to adjust the keyboard position and/or the screen position.

On the other hand, desktop computer can be set up as a workspace to offer a comfortable and ergonomically safe environment. The screen monitor of the desktop computer can be selectively elevated at a desired position on the desk to eyelevel of the user and about an arm length from the user. At the mean time, the keyboard of the desktop computer can be adjusted that the top of the keyboard is slightly sloped away to the bottom so that the wrists of the user are in a neutral position when the fingers are placed on the keys. Setting a workspace in this ergonomic way will minimize strain on the eyes, neck, back, wrists as well as hands of the user.

### SUMMARY OF THE PRESENT INVENTION

The invention is advantageous in that it provides a portable computer, which is designed with a unique structural configuration to combine the features of a conventional notebook computer and a conventional desktop computer to offer better ergonomics as the conventional desktop computer does and to provide more freedom to use anywhere as the conventional notebook computer does.

Another advantage of the invention is to a portable computer, wherein an input device is adapted to selectively move away from a main body for ergonomically fitting the hand position of the user in a neutral position while the fingers of the user are placed on the keys.

Another advantage of the invention is to a portable computer, wherein the screen panel is elevated by the main body to an eyelevel of the user for enhancing the viewability of the screen panel.

Another advantage of the invention is to a portable computer, wherein when the input device is moved away in responsive to the screen panel, the screen panel is kept in an arm length from the user to offer a comfortable and ergonomically safe environment for the user.

Another advantage of the invention is to a portable computer, wherein the set up of the present invention is simple and easy by sliding the input device out of the main body and folding the supporting leg out of the main body.

Another advantage of the invention is to a portable computer, wherein the portable computer can be folded up by sliding the input device to the main body and pivotally folding the screen panel on the input device such that the portable computer is folded as the conventional notebook computer to enhance the portability of the portable computer.

Another advantage of the invention is to a portable computer, wherein when the portable computer is unfolded at the usage position, the heat dissipating outlet is uncovered or unblocked for enhancing the heat being dissipated from the computer component unit so as to prevent the overheating of the portable computer.

Another advantage of the invention is to a portable computer, wherein the portable computer can be an individual standalone unit to incorporate with an existing tablet computer by detachably attaching tablet to the portable computer.

Another advantage of the invention is to a portable computer, which does not involve complicated or expensive mechanical components so as to minimize the manufacturing cost of the present invention.

Another advantage of the invention is to provide a portable computer, wherein no expensive or complicated structure is required to employ in the present invention in order to achieve the above mentioned objects. Therefore, the present invention successfully provides an economic and efficient solution for providing a comfortable and ergonomically safe environment for the user.

Additional advantages and features of the invention will become apparent from the description which follows, and may be realized by means of the instrumentalities and combinations particular point out in the appended claims.

According to the present invention, the foregoing and other objects and advantages are attained by a portable computer adapted for being supported on a working surface, which comprises a display device defining a screen area thereat, and a portable computer coupled with the display device to fold between an operation position and a storage position.

The portable computer comprises a main body, having a receiving cavity, being movably coupled with the display device edge-to-edge, and an input device movably coupled with the main body. Accordingly at the storage position, the display device is folded on the main body to enclose the receiving cavity, and at the operation position, the display device is folded from the main body at a desired angle and is elevated by the main body at a predetermined eyelevel with respect to the working surface.

In addition, at the storage position, the input device is received within the receiving cavity of the main body and is covered by the display device, and at the operation position, the input device is moved out of the receiving cavity for offering an extended length from the display device.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a portable computer according to a preferred embodiment of the present invention.

FIG. 2 is a perspective view of the portable computer according to the preferred embodiment of the present invention, illustrating the portable computer at an operation position.

FIG. 3 is a side view of the portable computer according to the preferred embodiment of the present invention, illustrating the display device being elevated and the input device being moved to offer an extended length from the display device.

FIG. 4 is a rear perspective view of the portable computer according to the preferred embodiment of the present invention, illustrating the foldable frame being folded at the rear side of the main body.

FIG. 5 illustrates an alternative mode of the location of the computer component unit of the portable computer according to the preferred embodiment of the present invention, illustrating the computer component unit located at the input device.

FIG. 6 illustrates an alternative mode of the display device of the portable computer according to the preferred embodiment of the present invention, illustrating the display device and the input device being detachably coupled with the main body.

FIG. 7 is a perspective view of a portable computer according to a second preferred embodiment of the present invention.

### DETAILED DESCRIPTION OF THE PREFERRED EMBODIMENT

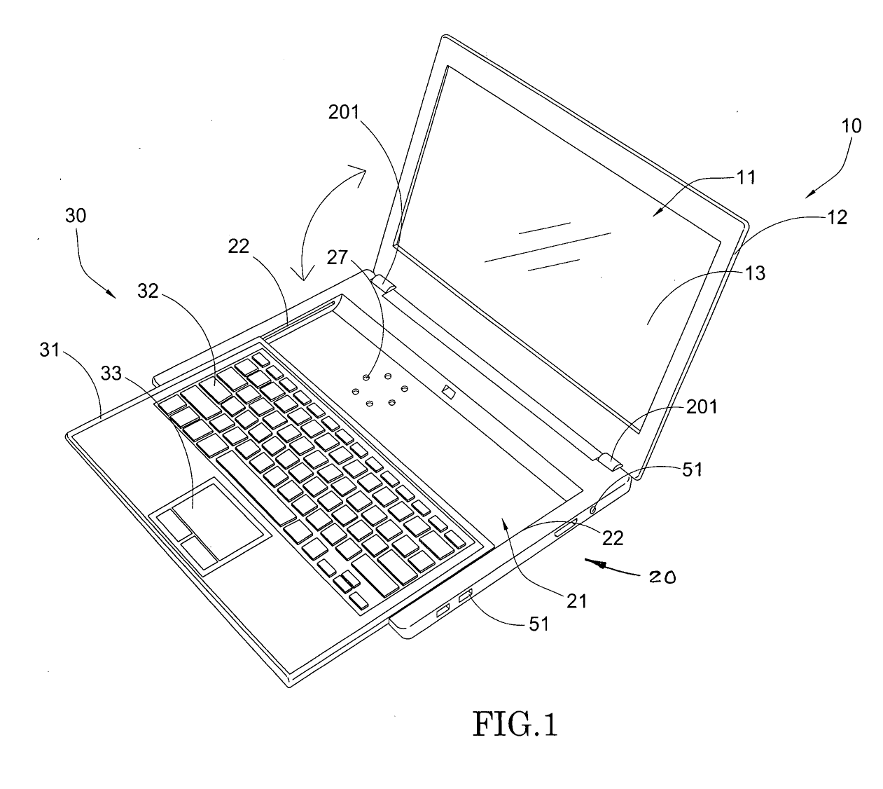

Referring to FIGS. 1 to 3 of the drawings, a portable computer according to a preferred embodiment of the present invention is illustrated, wherein the portable computer, which is adapted for being supported on a working surface, which comprises a display device 10 defining a screen area 11 thereat, and a portable computer coupled with the display device 10 to fold between an operation position and a storage position.

The portable computer comprises a main body 20 and an input device 30 movably coupled with the main body 20. The main body 20 includes computer components such as central processor unit, RAM, hard drive, mother board, and etc., received and installed therein. According to the present invention, the display device 10 is movably coupled with the main body 20 to selective adjust a desired angle between the main body 20 and the display device 10, such that a viewing angle of the screen area 11 of the display device 10 can be selectively adjusted with respect to the user posture.

Accordingly, at the storage position, the input device 30 and the display device 10 are moved toward the main body 20 at a position that the display device 10 is overlapped with the input device 30. At the operation position, the display device 10 is moved away from the main body 20 and is elevated by the main body 20 at a predetermined eyelevel with respect to the working surface while the input device 30 is moved away from the main body 20 at a direction opposite to the display device 10 for offering an extended length from the display device 10.

According to the preferred embodiment, the display device 10 comprises a screen housing 12 having a planar structure and a screen panel 13 supported at a front side of the screen housing 12 to define the screen area 11 thereat, wherein the screen panel 13 is preferably a LCD panel or a LED flat panel. The screen panel 13 can also be a touch screen device that can detects the presence and location of a touch within the screen area 11.

The main body 20 is made of rigid but lightweight material to support the display device 10 at an elevated position, wherein the main body 20 has a corresponding size and shape matching with the size and shape of the display device 10. Accordingly, a rear edge of the main body 20 is pivotally coupled with a front edge of the display device 10 via a pivot hinge 201, wherein the display device 10 is adapted to pivotally fold with respect to the main body 20 and to retain at the desired angle via the pivot hinge 201 as the conventional notebook does. In addition, the display device 10 can also pivotally fold flat on the main body 20 to enclose the receiving cavity 21 and to protect the screen area 11 of the display device 10.

The main body 20 has a receiving cavity 21 at a top side of the main body 20, wherein the display device 10 is movably coupled with main body 20 edge-to-edge. Accordingly, at the storage position, the display device 10 is folded on the main body 20 to enclose the receiving cavity 21. In addition, at the storage position, the input device 30 is received within the receiving cavity 21 of the main body 20 and is covered by the display device 10. Accordingly, the display device 10 is operatively linked to the input device 30 via a connection cable, wherein the connection cable is embedded within the main body 20 to operatively link the input device 30 to the display device 10.

At the operation position, the display device 10 is folded from the main body 20 at a desired angle and is elevated by the main body 20 at a predetermined eyelevel with respect to the working surface. In addition, the input device 30 is moved out of the receiving cavity 21 for offering an extended length from the display device 10.

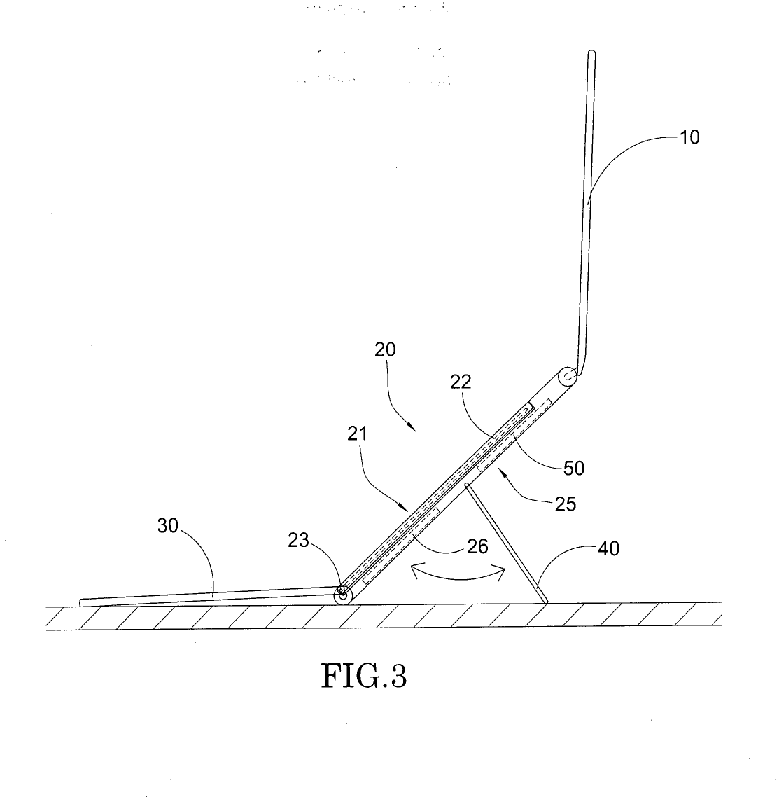

As shown in FIG. 3, the main body 20 is inclinedly supported on the working surface at the operation position to elevate the display device 10 at an eyelevel of the user. In other words, the main body 20 is supported at an inclined manner that the front edge of the main body 20 is laid on the working surface while the rear edge of the main body 20 is upwardly extended and suspended above the working surface. Therefore, the display device 10 is elevated from the rear edge of the main body 20 to match with the eyelevel of the user. It is worth mentioning that the main body 20 not only forms a screen elevation frame to elevate the screen area 11 of the display device 10 but also forms an input extension frame to substantially prolong the distance of the input device 30 from the display device 10.

The input device 30 comprises an input panel 31 defining a keyboard 32 and a pointing device 33 thereon, wherein the size and shape of the input device 30 matches with the size and shape of the receiving cavity 21 such that the input device 30 is adapted to fit in the receiving cavity 21. In addition, a thickness of the input device 30 should be smaller that the depth of the receiving cavity 21 such that when the input device 30 is received in the receiving cavity 21, the display device 10 is adapted to pivotally fold flat on the main body 20 to cover the keyboard 32 and the pointing device 33. Accordingly, the pointing device 33 can be a touchpad, a trackpad, or a pointing stick.

As shown in FIG. 1, the main body 20 further comprises two sliding tracks 22 provided at two sidewalls of the receiving cavity 21 to slidably couple with two side peripheral edges of the input device 30, wherein the input device 30 is adapted to slide into the receiving cavity 21 at the storage position and to slide out of the receiving cavity 21 at the operation position.

Each of the sliding tracks 22 has a U-shaped cross section to slidably engage with the side peripheral edge of the input panel 31 of the input device 30, and a front opening for enabling the input panel 31 of the input device 30 sliding out of the receiving cavity 21 through the front opening.

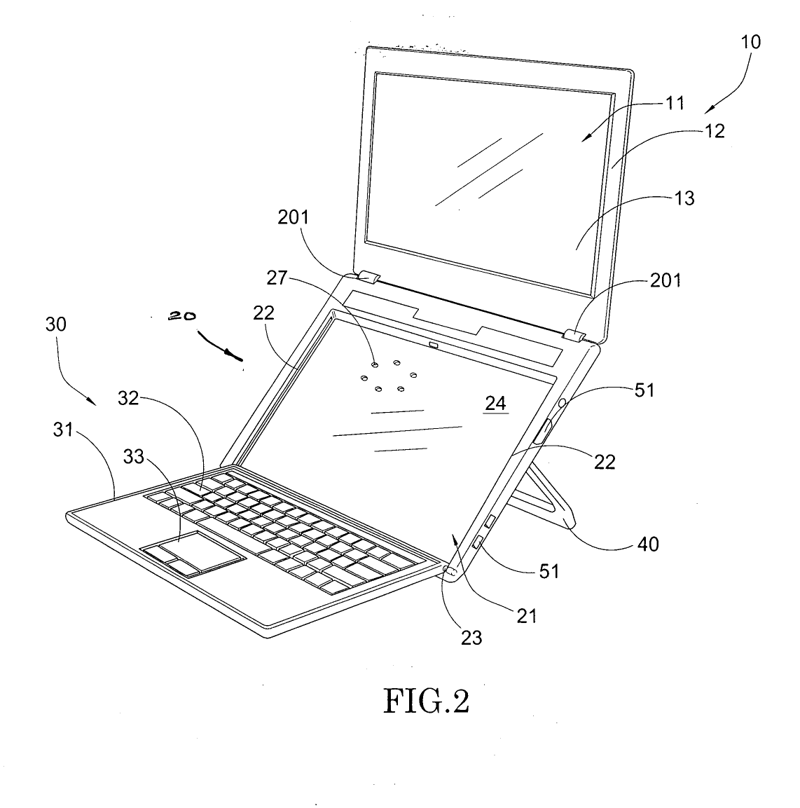

As shown in FIG. 2, the input device 30 is slid out of the receiving cavity 21 of the main body 20 at a position that a rear edge of the input device 30 is aligned at the front opening of the receiving cavity 21. Therefore, the distance between the display device 10 and the input device 30 will be substantially increased to keep a proper distance of the screen area 11 of the display device 10 from the eyes of the user.

In addition, the main body 20 further comprises two sliding stoppers 23 provided at two outer ends of the sliding tracks 22 respectively to block a further sliding movement of the input device 30 and to maintain the input device 30 at a slanted manner. As shown in FIG. 3, the sliding stoppers 23 are provided within the sliding tracks 22 respectively at the front opening of the receiving cavity 21 to prevent the input device 30 being slid to detach from the main body 20. In addition, the input device 30 is sloped downward, i.e. the rear edge of the input device 30 is slightly elevated by the sliding stoppers 23 at the sliding tracks 22, wherein the rear edge of the input device 30 is slightly sloped away to the front edge thereof so that the wrists of the user are in a neutral position when the fingers are placed on the keys of the keyboard 31. It is appreciated that the user is able to further slide the input device 30 along the sliding tracks 22 to bypass the sliding stoppers 23 such that the input device 30 can be laid flat on the working surface.

As shown in FIG. 1, the main body 20 further comprises a supporting platform 24 defining the receiving cavity 21 above the supporting platform 24, wherein the two sliding tracks 21 are provided at two side edges of the supporting platform 24 respectively. Therefore, when the input device 30 is slid into the receiving cavity 21, the input device 30 is supported above the supporting platform 24.

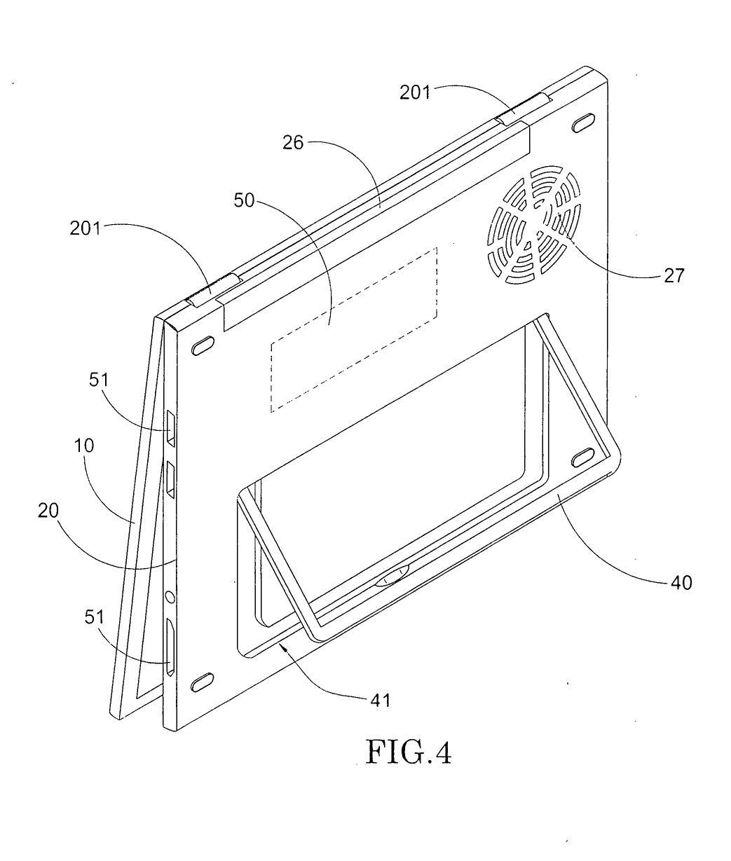

In order to retain the elevated position of the main body 20, the portable computer may further comprises a supporter 40 which can be all kinds of stands or legs for supporting the main body 20 inclindedly supported on the working surface to elevate the display device 10. According to the preferred embodiment of the present invention, the supporter 40 is embodied as a foldable frame 40 pivotally coupled at a bottom side of the main body 20, as shown in FIG. 4.

Accordingly, the foldable frame 40 is adapted to pivotally fold at the bottom side of the main body 20, i.e. the bottom side of the supporting platform 24, to store the foldable frame 40. When the foldable frame 40 is pivotally away from the bottom side of the main body 20 to stand on the working surface, the main body 20 is inclinedly supported on the working surface to elevate the display device 10, as shown in FIG. 3. According to the preferred embodiment, the foldable frame 40 has a U-shaped structure defining two extending leg portions pivotally coupled with the bottom side of the main body 20 and a longitudinal standing portion extended between the extending leg portions to support the main body 20 on the working surface in an inclined manner.

In particular, the portable computer further has a folding cavity 41 indented on the bottom side of the main body 20, i.e. the bottom side of the supporting platform 24, to receive the foldable frame 40, wherein the folding cavity 41 has a size and shape matching with the size and shape of the foldable frame 40. Therefore, when the foldable frame 40 is pivotally folded in the folding cavity 41, the bottom side of said main body 20 forms a flat surface for resting on the working surface, and when the foldable frame 40 is pivotally folded out of the folding cavity 41, the main body 20 is inclinedly supported on the working surface to elevate the display device 10.

Therefore, the portable computer of the present invention can be set up to offer a comfortable and ergonomically safe environment for the user by sliding the input device 30 from the main body 20 and by elevating the display device 10 by the main body 20 such that the portable computer of the present invention can be stably supported on the working surface via the foldable frame 40.

According to the preferred embodiment, the portable computer further comprises a computer component unit 50 operatively linked between the display device 10 and the input device 30, wherein the computer component unit 50 comprises all essential computer components including motherboard, CPU, memory, graphics adapter, hard drive, and/or optical drive such as CD ROM or DVD ROM. Preferably, the computer component unit 50 is received in the main body 20.

Accordingly, the computer component unit 50 can be operatively linked to the to input device 30 by wiring through one of the sliding tracks 22. Preferably, the computer component unit 50 can be operatively linked to the input device 30 through wireless connection such as “Bluetooth” or infrared connection.

Accordingly, the portable computer further comprises a component housing 25 provided at the main body 20 to receive the computer component unit 50 and a battery compartment 26 provided at the bottom side of the main body 20 to receive a rechargeable battery thereat to electrically link to the computer component unit 50, wherein a weight of each of the display device 10 and the input device 30 will be minimized and the portable computer will be maintained in a balance manner on the working surface when the portable computer is folded at the operation position.

As shown in FIG. 3, the component housing 25 is formed underneath the supporting platform 24 to house and protect the computer component unit 50, wherein the display device 10 and the input device 30 are operatively linked to the computer component unit 50. Therefore, the weight of the display device 10 will be substantially reduced by re-configuring the display controller component in the component housing 25. The thickness of the display device 10 will also be significantly reduced to form a thin flat display panel. Likewise, the thickness of the input device 30 will also be reduced. It is worth mentioning that the weight of the main body 20 with the computer component unit 50 housed therein will be relatively heavier than the display device 10 and the input device 30. Having being supported by the foldable frame 40, the main body 20 will be stably supported on the working surface while the center of mass of the portable computer will be located at the main body 20 to keep the portable computer at the operation position in a balance manner. It is worth mentioning that the battery compartment 26 is preferably located closed the rear edge of the main body 20 at the bottom side thereof.

The portable computer further comprises a plurality of peripheral communication ports 51 provided at an outer peripheral side of the main body 20 to operatively link to the computer component unit 50 for detachably linking with a peripheral computer device. The peripheral communication ports 51 are USB port, network connector, express card slot, VGA port, AC adapter connector, audio jacks, etc, wherein the peripheral communication portions 51 are preferably provided at two peripheral sides of the main body 20.

Another major drawback of the conventional notebook is the overheat problem since the air vent is blocked by the working surface when the conventional notebook is supported on the working surface. According to the preferred embodiment, the portable computer further has a heat dissipating outlet 27 formed at the bottom side of the main body 20 for heat dissipation, wherein when the main body 20 is inclinedly supported on the working surface, the heat dissipating outlet 27 is uncovered or unblocked for enhancing the heat being dissipated. In other words, the bottom side of the main body 20 is inclinedly lifted above the working surface for enhancing the air circulation. In addition, the heat dissipating outlet 27 is also provided at the top side of the main body 20, i.e. the bottom side of the receiving cavity 21 such that when the input device 30 is slid out of the receiving cavity 21, the heat from the computer component unit 50 will dissipate out of the main body 20 from the heat dissipating outlet 27 not only at the top side of the main body 20 but also at the bottom side of the main body 20.

Accordingly, the portable computer of the present invention is adapted to fold among three different positions, i.e. the storage position and two different operation positions. One of the operation positions of the portable computer is a conventional notebook operation position while another operation position of the portable computer is an ergonomically workspace operation position.

According to the preferred embodiment, the portable computer of the present invention can be folded as the conventional notebook, wherein the input device 30 is slid into the main body 20 and is covered by the display device 10 by pivotally folding the display device 10 on top of the main body 20. Therefore, the portable computer of the present invention is folded up as the conventional notebook to form a compact structure. In other words, the portable computer of the present invention is easy to pack up and can be used anywhere.

The portable computer of the present invention can be used as the conventional notebook, wherein the display device 10 is pivotally and upwardly folded from the main body 20 while the input device 30 is remained at the main body 20. Therefore, the portable computer of the present invention can be used as the conventional notebook to place the portable computer on the lap of the user. It is worth mentioning the when the foldable frame 40 is folded into the folding cavity 41, the bottom side of the main body 20 forms a flat surface to place on the lap of the user.

As it is mentioned above, the portable computer of the present invention can also be set up to offer a comfortable and ergonomically safe environment for the user. The input device 30 can be slid out from the main body 20 and can be retained at a slanted position so that the wrists of the user are in a neutral position when the fingers are placed on the keys. The display device 10 will be elevated by the main body 20 to an eyelevel of the user to avoid neck fatigue and headaches of the user. In addition, since the input device 30 is slid out from the main body 20, the distance between the input device 30 and the display device 10 will be increased, such that the display device 10 will be about an arm length from the user. The foldable frame 40 is pivotally folded from the folding cavity 41 to stand on the working surface. Therefore, the foldable frame 40, the main body 20 and the working surface form a triangular configuration to stably support the portable computer of the present invention on the working surface in a balance manner.

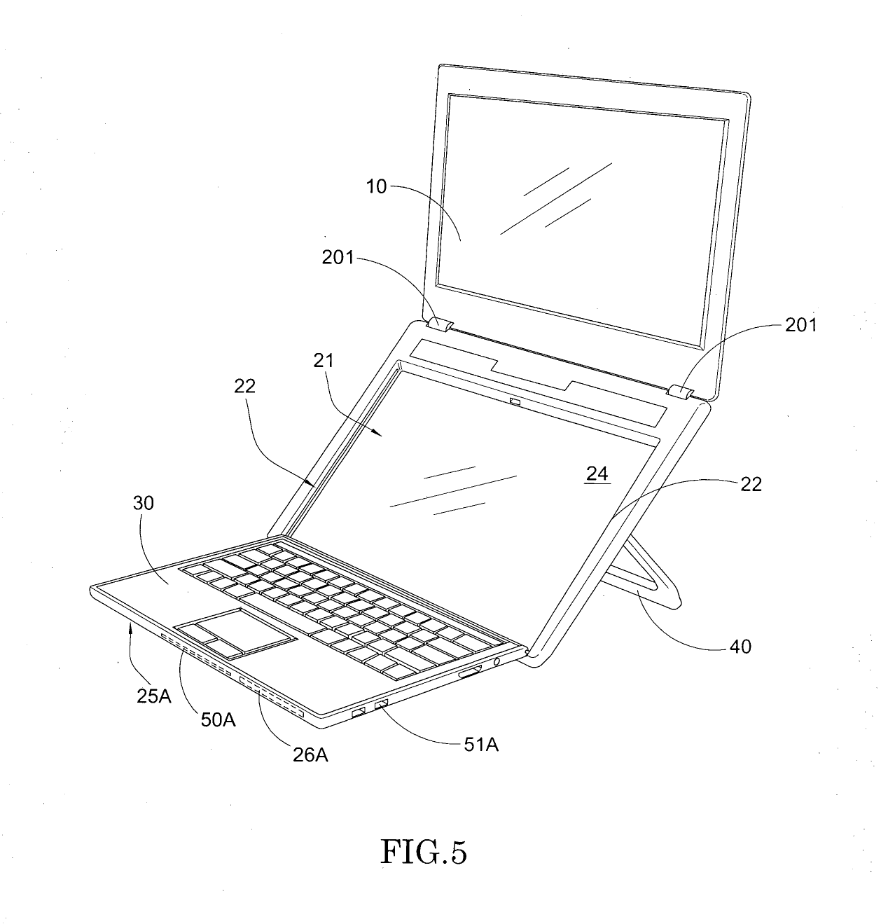

FIG. 5 illustrates an alternative mode of location of the computer component unit 50A, wherein the computer component unit 50A is housed within the input device 30 to operatively link to the display device 10. Accordingly, the connection cable is embedded within the main body 20 to operatively link the computer component unit 50A to the display device 10. In particular, the component housing 25A is integrally formed with the input device 30 to house the computer component unit 50A. In addition, the battery compartment 26A is provided at the bottom side of the input device 30 to receive a rechargeable battery thereat to electrically link to the computer component unit 50A. In other words, the main body 20 forms as a support stand to support and elevate the display device 10 and to guide the sliding movement of the input device 30. It is worth mentioning that the main body 20 is embodied to have an accessing opening aligning with the battery compartment 26A to access the rechargeable battery, such as attaching/detaching operation of the rechargeable battery, when the input device 30A is slid within the main body 20. It is appreciated that the peripheral communication ports 51A are provided at an outer peripheral side of the input device 30 to operatively link to the computer component unit 50A for detachably linking with a peripheral computer device.

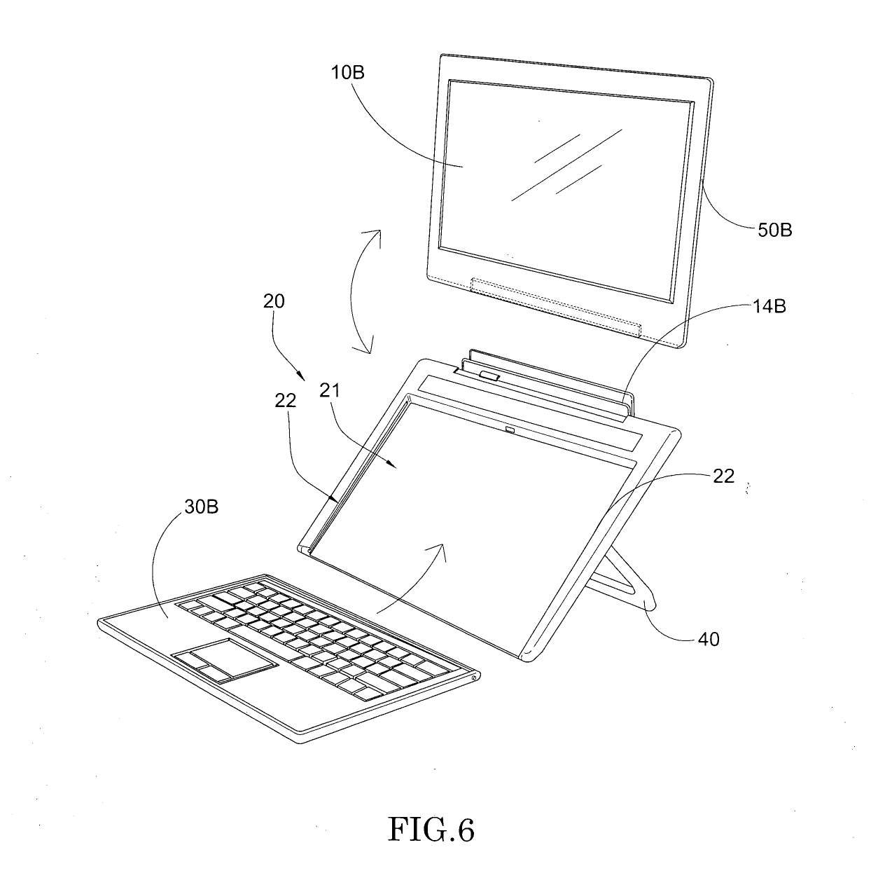

FIG. 6 further illustrates another alternative mode of the portable computer, wherein the display device 10B is detachably coupled with the main body 20 via a display adapter 14B. As shown in FIG. 6, the display adapter 14B, preferably having a U-shaped cross section, is provided at the rear edge of the main body 20 to detachably couple with the display device 10B. In addition, the display adapter 14B also forms as the pivot hinge 201 that when the display device 10B is detachably coupled at the display adapter 14B, the display device 10B is adapted to pivotally fold and overlap on the main body 20. In other words, the display adapter 14B forms as a detachable coupler and the pivot hinge to enable the display device 10B being detachably coupled and pivotally folded with the main body 20.

Accordingly, the display device 10B is embodied as a tablet computer having touch screen ability, wherein the computer component unit 50B is housed within the display device 10B to operatively link to the input device 30B, preferably through wireless connection such as “Bluetooth” or infrared connection. Therefore, the portable computer of the present invention can be an individual standalone unit as a docking station to incorporate with any existing tablet computer by detachably attaching tablet computer to the portable computer.

FIG. 6 further illustrates an alternative mode of input device 30B which is detachably coupled with the main body 20. Accordingly, the input device 30B can be entirely slid out of the receiving cavity 21 of the main body 20 via the sliding tracks 21 thereof. Or, the input device 30B can be directly taken out from the receiving cavity 21 of the main body 20. In other words, the display device 10B, the main body 20, and the input device 30B are configured to be three individual elements to fit the need of the user. The user is able to detach the display device 10B from the portable computer to use the display device 10B as the tablet computer. Once the display device 10B is attached to the portable computer, the user is able to use it as the conventional notebook computer by placing the portable computer on the lap of the user. The portable computer can also be transformed in a comfortable and ergonomically safe workspace that the display device 10B is attached to the portable computer and is elevated by the main body 20 while the input device 30B is moved out from the main body 20.

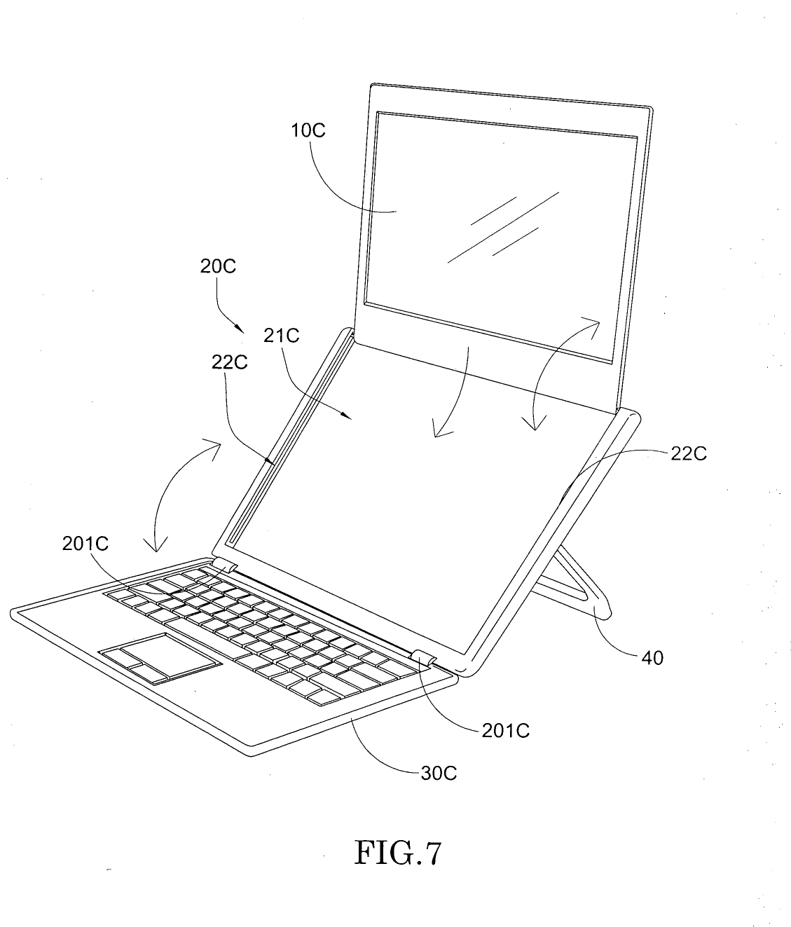

As shown in FIG. 7, a portable computer of a second embodiment illustrates an alternative mode the above embodiment, wherein the structural configuration of the main body 20C is the same as that of the first embodiment. In other words, the connection between the display device 10C and the main body 20C is a sliding connection while the connection between the input device 30C and the main body 20C is a pivot connection.

As shown in FIG. 7, the display device 10C is slidably coupled with the main body 20C, wherein the two sliding tracks 22C are provided at two sidewalls of the receiving cavity 21C to slidably couple with two side peripheral edges of the display device 10C. In addition, when the display device 10C is slid out of the receiving cavity 21C and is retained at a position that the front edge of the display device 10C is aligned with the rear edge of the main body 20C, the display device 10C can be pivotally folded with respect to the main body 20C.

The input device 30C is pivotally coupled with the main body via the pivot hinge 201C such that the input device 30C can be pivotally folded on the main body 20C.

Accordingly, at the storage position, the display device 10C is received within the receiving cavity 21C of the main body 20C and is covered by the input device 30C, and at the operation position, the display device 10C is moved out of the receiving cavity 21C and is folded at a desired angle while the display device 10C is elevated by the main body 20C at a predetermined eyelevel with respect to the working surface. In addition, at the storage position, the input device 30C is folded on the main body 20C to enclose the receiving cavity 21C, and at the operation position, the input device 30C is pivotally folded from the main body 20C for offering an extended length from the display device 10C.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable computer, comprising:
a display device defining a screen area thereat; and
a computer, which is arranged for placing on a working surface, coupled with said display device to fold between an operation position and a storage position, comprising:
a main body, wherein said display device is movably coupled with said main body to selective adjust a desired angle between said main body and said display device; and
an input device movably coupled with said main body and operatively linked to said display device, wherein at said storage position, said input device and said display device are moved toward said main body at a position that said display device is overlapped with said input device, and at said operation position, said display device is moved away from said main body and is elevated by said main body at a predetermined eyelevel with respect to said working surface while said input device is moved away from said main body at a direction opposite to said display device for offering an extended length from said display device.

2. The portable computer, as recited in claim 1, wherein said main body has a receiving cavity to receive said input device, wherein at said storage position, said input device is received in said receiving cavity and said display device is folded on said main body to enclose said receiving cavity, and at said operation position, said input device is moved out of said receiving cavity for offering said extended length from said display device.

3. The portable computer, as recited in claim 2, wherein said main body further comprises two sliding tracks provided at two sidewalls of said receiving cavity to slidably couple with two side peripheral edges of said input device, such that said input device is adapted to slide into said receiving cavity at said storage position and to slide out of said receiving cavity at said operation position.

4. The portable computer, as recited in claim 3, wherein said main body further comprises two sliding stoppers provided at two outer ends of said sliding tracks respectively to block a further sliding movement of said input device and to maintain said input device at a slanted manner.

5. The portable computer, as recited in claim 1, wherein said computer further comprises a supporter movably coupled with said main body and arranged in such a manner that when said supporter is moved away from said main body for standing on a working surface, said main body is inclinedly supported on the working surface to elevate said display device.

6. The portable computer, as recited in claim 2, wherein said computer further comprises a supporter movably coupled with said main body and arranged in such a manner that when said supporter is moved away from said main body for standing on a working surface, said main body is inclinedly supported on the working surface to elevate said display device.

7. The portable computer, as recited in claim 4, wherein said computer further comprises a supporter movably coupled with said main body and arranged in such a manner that when said supporter is moved away from said main body for standing on a working surface, said main body is inclinedly supported on the working surface to elevate said display device.

8. The portable computer, as recited in claim 5, wherein said supporter is a folding frame pivotally coupled to a bottom side of said main body and said computer further has a folding cavity indented on said bottom side of said main body to receive said foldable frame, in such a manner that when said foldable frame is pivotally folded in said folding cavity, said bottom side of said main body forms a flat surface for resting on said working surface, and when said foldable frame is pivotally folded out of said folding cavity, said main body is inclinedly supported on said working surface to elevate said display device.

9. The portable computer, as recited in claim 6, wherein said supporter is a folding frame pivotally coupled to a bottom side of said main body and said computer further has a folding cavity indented on said bottom side of said main body to receive said foldable frame, in such a manner that when said foldable frame is pivotally folded in said folding cavity, said bottom side of said main body forms a flat surface for resting on said working surface, and when said foldable frame is pivotally folded out of said folding cavity, said main body is inclinedly supported on said working surface to elevate said display device.

10. The portable computer, as recited in claim 7, wherein said supporter is a folding frame pivotally coupled to a bottom side of said main body and said computer further has a folding cavity indented on said bottom side of said main body to receive said foldable frame, in such a manner that when said foldable frame is pivotally folded in said folding cavity, said bottom side of said main body forms a flat surface for resting on said working surface, and when said foldable frame is pivotally folded out of said folding cavity, said main body is inclinedly supported on said working surface to elevate said display device.

11. The portable computer, as recited in claim 5, wherein said computer further has a heat dissipating outlet formed at said bottom side of said main body for heat dissipation, such that when said main body is inclinedly supported on said working surface, said heat dissipating outlet is uncovered for enhancing said heat being dissipated.

12. The portable computer, as recited in claim 7, wherein said computer further has a heat dissipating outlet formed at said bottom side of said main body for heat dissipation, such that when said main body is inclinedly supported on said working surface, said heat dissipating outlet is uncovered for enhancing said heat being dissipated.

13. The portable computer, as recited in claim 10, wherein said computer further has a heat dissipating outlet formed at said bottom side of said main body for heat dissipation, such that when said main body is inclinedly supported on said working surface, said heat dissipating outlet is uncovered for enhancing said heat being dissipated.

14. The portable computer, as recited in claim 13, wherein said main body further comprises a supporting platform defining said two sliding tracks at two side edges of said supporting platform and said folding cavity at a bottom side of said supporting platform, wherein said input device is slidably received in said receiving cavity at a position above said supporting platform.

15. The portable computer, as recited in claim 1, wherein said computer further comprises a computer component unit operatively linked between said display device and said input device, wherein said computer further comprises a component housing provided at said main body to receive said computer component unit to minimize a weight of each of said display device and said input device and to maintain said portable computer in a balance manner on said working surface when said portable computer is folded at said operation position.

16. The portable computer, as recited in claim 7, wherein said computer further comprises a computer component unit operatively linked between said display device and said input device, wherein said computer further comprises a component housing provided at said main body to receive said computer component unit to minimize a weight of each of said display device and said input device and to maintain said portable computer in a balance manner on said working surface when said portable computer is folded at said operation position.

17. The portable computer, as recited in claim 14, wherein said computer further comprises a computer component unit operatively linked between said display device and said input device, wherein said computer further comprises a component housing provided at said main body to receive said computer component unit to minimize a weight of each of said display device and said input device and to maintain said portable computer in a balance manner on said working surface when said portable computer is folded at said operation position.

18. The portable computer, as recited in claim 15, wherein said computer further comprises a plurality of peripheral communication ports provided at an outer peripheral side of said main body to operatively link to said computer component unit for detachably linking with a peripheral computer device.

19. The portable computer, as recited in claim 16, wherein said computer further comprises a plurality of peripheral communication ports provided at an outer peripheral side of said main body to operatively link to said computer component unit for detachably linking with a peripheral computer device.

20. The portable computer, as recited in claim 17, wherein said computer further comprises a plurality of peripheral communication ports provided at an outer peripheral side of said main body to operatively link to said computer component unit for detachably linking with a peripheral computer device.

21. The portable computer, as recited in claim 1, wherein said computer further comprises a computer component unit operatively linked between said display device and said input device, wherein said computer component unit is received in said input device.

22. The portable computer, as recited in claim 7, wherein said computer further comprises a computer component unit operatively linked between said display device and said input device, wherein said computer component unit is received in said input device.

23. The portable computer, as recited in claim 14, wherein said computer further comprises a computer component unit operatively linked between said display device and said input device, wherein said computer component unit is received in said input device.

24. The portable computer, as recited in claim 15, wherein said computer further comprises a plurality of peripheral communication ports provided at an outer peripheral side of said input device to operatively link to said computer component unit for detachably linking with a peripheral computer device.

25. The portable computer, as recited in claim 16, wherein said computer further comprises a plurality of peripheral communication ports provided at an outer peripheral side of said input device to operatively link to said computer component unit for detachably linking with a peripheral computer device.

26. The portable computer, as recited in claim 17, wherein said computer further comprises a plurality of peripheral communication ports provided at an outer peripheral side of said input device to operatively link to said computer component unit for detachably linking with a peripheral computer device.
